(19) United States
(12) Patent Application Publication
(10) Pub. No.: US 2011/0231291 A1
(43) Pub. Date: Sep. 22, 2011

(54) PRICE DISTRIBUTION SLIDER HISTOGRAM

(75) Inventors: Steve Yankovich, San Jose, CA (US); Ryan Melcher, Ben Lomond, CA (US); Ganga Muthyala, San Jose, CA (US)

(73) Assignee: eBay Inc., San Jose, CA (US)

(21) Appl. No.: 13/051,476

(22) Filed: Mar. 18, 2011

Related U.S. Application Data
(60) Provisional application No. 61/315,816, filed on Mar. 19, 2010.

(51) Int. Cl. G06Q 30/00; G06F 17/30

(52) U.S. Cl. 705/27.1; 707/766; 707/E17.014

(57) ABSTRACT

In various example embodiments, systems and methods to navigate item listings using a slider histogram include receiving a request from a client device and determining a list of item listings satisfying the request. Additionally, a histogram based on an attribute found in the item listings of the list is determined. The list and the histogram are provided to the client device, the histogram including a slider that allows refinement of the item listings being displayed based on a position of the slider on the histogram.

### CROSS-REFERENCE TO RELATED APPLICATIONS

This application claims the benefit of the filing date of U.S. Provisional Application Ser. No. 61/315,816, filed Mar. 19, 2010, and entitled “PRICE DISTRIBUTION SLIDER HISTOGRAM,” which is incorporated herein by reference in its entirety.

### TECHNICAL FIELD

Example embodiments of the present disclosure relate generally to the field of computer technology and, more specifically, to providing and using a price distribution slider histogram.

### BACKGROUND

Websites provide a number of publishing, listing, and price-setting mechanisms whereby a publisher (e.g., a seller) may list or publish information concerning items for sale. The process of creating a listing may be a time-consuming and tedious process. The seller may not have a good idea of what the selling price should be, how much to charge for shipping, or what should go in a description for their item.

### BRIEF DESCRIPTION OF DRAWINGS

Various ones of the appended drawings merely illustrate example embodiments of the present disclosure and are not to be considered to be limiting its scope.

FIG. 1 is a block diagram illustrating an example embodiment of a network architecture of a system used to identify items depicted in images.

FIG. 2 is a block diagram illustrating an example embodiment of a publication system.

FIG. 3 is a block diagram illustrating an example embodiment of a listing creation engine.

FIG. 4 is a block diagram illustrating an example embodiment of a device selling system.

FIG. 5 is a flow diagram of an example method for creating a listing for an item.

FIG. 6 is an example user interface illustrating a pricing histogram on a price history display.

FIG. 7 is an example user interface illustrating a “sell one like this” option.

FIG. 8 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide an understanding of various embodiments of the inventive subject matter. It will be evident, however, to those skilled in the art that embodiments of the disclosed subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a network-based publication environment, the embodiments are given merely for clarity in disclosure. Thus, any type of electronic publication, electronic commerce, or electronic business system and method, including various system architectures, may employ various embodiments of the listing creation system and method described herein and be considered as being within a scope of the example embodiments. Each of a variety of example embodiments is discussed in detail below.

Example embodiments described herein provide systems and methods to navigate previously sold and, in some cases, presently available items using a price distribution slider histogram. The slider histogram allows users to visualize the price distribution of sold and active items, displays average prices, and enables refinement of the search results by using a slider of the histogram. This allows sellers to research sale trends and determine a going rate for an item. With this information in hand, users can make their items more sellable by pricing them appropriately.

In further embodiments, listings may be easily created based on information accessed using the slider histogram. When a user finds a previously sold item (or currently available item) that is similar or identical to one that the seller wants to sell, the seller may, with a single action (e.g., one click), pre-populate a listing template. The listing template is pre-populated with information and attributes from the previously sold item listing such as, for example, category, price, title, images, and description. The seller may simply approve the listing template or modify the listing template and post a listing based on the listing template to the network-based publication environment.

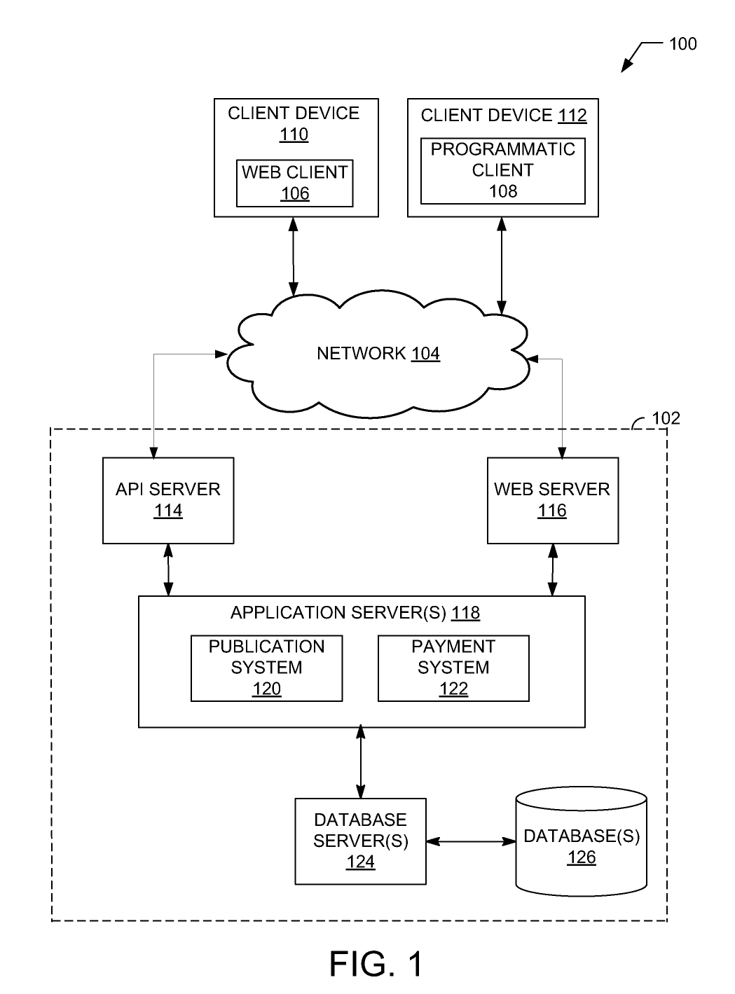

With reference to FIG. 1, an example embodiment of a high-level client-server-based network architecture 100 to provide content based on an image is shown. A networked system 102, in an example form of a network server-side functionality, is coupled via a communication network 104 (e.g., the Internet, wireless network, cellular network, or a Wide Area Network (WAN)) to one or more client devices 110 and 112. FIG. 1 illustrates, for example, a web client 106 operating via a browser (e.g., such as the INTERNET EXPLORER® browser developed by Microsoft® Corporation of Redmond, Wash. State), and a programmatic client 108 executing on respective client devices 110 and 112.

The client devices 110 and 112 may comprise a mobile phone, desktop computer, laptop, or any other communication device that a user may utilize to access the networked system 102. In some embodiments, the client devices 110 may comprise or be connectable to an image capture device (e.g., camera). The client device 110 may also comprise a voice recognition module (not shown) to receive audio input and a display module (not shown) to display information (e.g., in the form of user interfaces). In further embodiments, the client device 110 may comprise one or more of a touch screen, an accelerometer, and a Global Positioning System (GPS) device.

An Application Program Interface (API) server 114 and a web server 116 are coupled to, and provide programmatic and web interfaces respectively to, one or more application servers 118. The application servers 118 host a publication system 120 and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or database(s) 126. In one embodiment, the databases 126 may comprise a knowledge database that may be updated with content, user preferences, and user interactions (e.g., feedback, surveys, etc.).

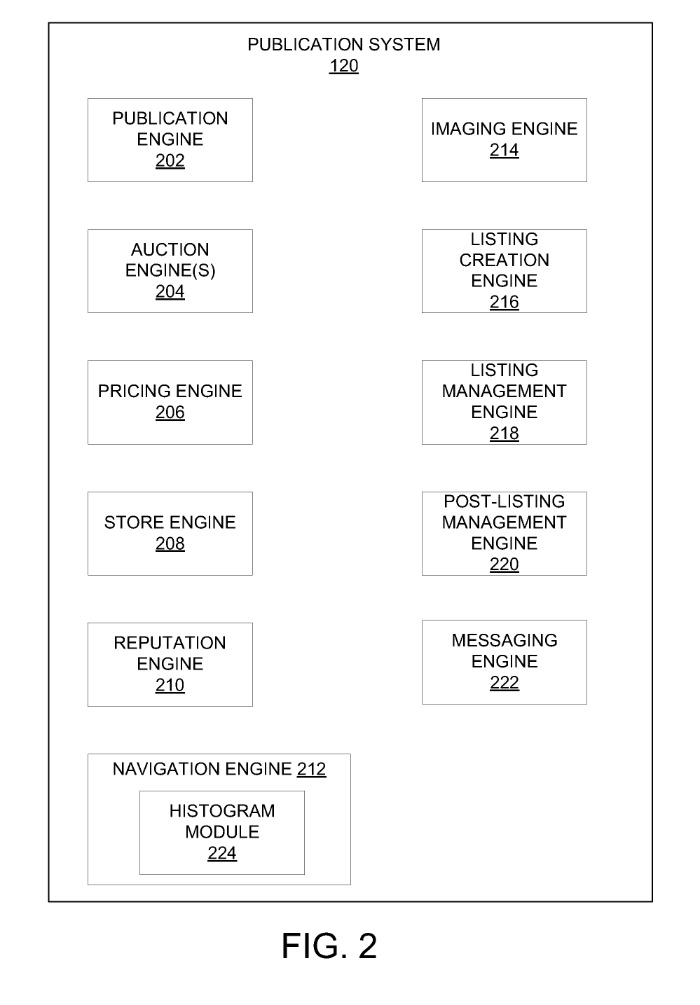

The publication system 120 publishes content on a network (e.g., the Internet). As such, the publication system 120 provides a number of publication and marketplace functions and services to users that access the networked system 102. The publication system 120 is discussed in more detail in connection with FIG. 2. While the publication system 120 is discussed in terms of a marketplace environment, it is noted that the publication system 120 may be associated with a non-marketplace environment.

The payment system 122 provides a number of payment services and functions to users. The payment system 122 allows users to accumulate value (e.g., in a commercial currency, such as the U.S. dollar, or a proprietary currency, such as “points”) in accounts, and then later to redeem the accumulated value for products (e.g., goods or services) that are made available via the publication system 120. The payment system 122 also facilitates payments from a payment mechanism (e.g., a bank account, PayPal account, or credit card) for purchases of items via the network-based marketplace. While the publication system 120 and the payment system 122 are shown in FIG. 1 to both form part of the networked system 102, it will be appreciated that, in alternative embodiments, the payment system 122 may form part of a payment service that is separate and distinct from the networked system 102.

While the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities.

Referring now to FIG. 2, an example block diagram illustrating multiple components that, in one example embodiment, are provided within the publication system 120 of the networked system 102 (see FIG. 1), is shown. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more database(s) 126 via the one or more database servers 124, both shown in FIG. 1.

In one embodiment, the publication system 120 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 202 and one or more auction engines 204 that support auction-format listing and price setting mechanisms (e.g., English, Dutch, Chinese, Double, reverse auctions, etc.). The various auction engines 204 also provide a number of features in support of these auction-format listings, such as a reserve price feature whereby a seller may specify a reserve price in connection with a listing and a proxy-bidding feature whereby a bidder may invoke automated proxy bidding.

A pricing engine 206 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay Inc., of San Jose, Calif.) may be offered in conjunction with auction-format listings and may allow a buyer to purchase goods or services, which are also being offered for sale via an auction, for a fixed price that is typically higher than a starting price of an auction for an item.

A store engine 208 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 210 allows users that transact, utilizing the networked system 102, to establish, build, and maintain reputations. These reputations may be made available and published to potential trading partners. Because the publication system 120 supports person-to-person trading between unknown entities, users may otherwise have no history or other reference information whereby the trustworthiness and credibility of potential trading partners may be assessed. The reputation engine 210 allows a user, for example through feedback provided by one or more other transaction partners, to establish a reputation within the network-based publication system over time. Other potential trading partners may then reference the reputation for purposes of assessing credibility and trustworthiness.

Navigation of the network-based publication system may be facilitated by a navigation engine 212. For example, a search module (not shown) of the navigation engine 212 enables keyword searches of listings published via the publication system 120. In a further example, a browse module (not shown) of the navigation engine 212 allows users to browse various category, catalog, or inventory data structures according to which listings may be classified within the publication system 120. The search module and the browse module may provide retrieved search results or browsed listings to a client device. Various other navigation applications within the navigation engine 212 may be provided to supplement the searching and browsing applications.

A histogram module 224 of the navigation engine 212 works in conjunction with the search module or browse module to provide search results based on a histogram of an attribute distribution (e.g., price distribution). In example embodiments, the histogram module 224 generates a histogram associated with a search result. The histogram module 224 also provides a slider user interface element at a bottom of a user interface. As a user moves the slider along a price distribution range on the slider histogram, listings displayed in the user interface are updated to prioritize and display listings that fall within the price distribution range. For example, moving the slider along a price distribution histogram will focus the results on a set of listings having a price within the range indicated by the slider. In one embodiment, the slider element may be touch-enabled so as to allow a user to use a finger or stylus to move the slider. The histogram module 224 may provide the generated histogram to the client device.

While embodiments of the present application provide a price distribution slider histogram (e.g., the attribute being price), it is noted that other attributes may be used to determine a slider histogram. For example, a slider histogram based on attributes such as location (e.g., distance from user), sizes of items, colors, item condition, or seller reputations may be utilized. Additionally, the functions of the histogram module 224 may be embodied on a similar module located at the client device 110.

In order to make listings available via the networked system 102 as visually informing and attractive as possible, the publication system 120 may include an imaging engine 214 that enables users to upload images for inclusion within listings and to incorporate images within viewed listings. The imaging engine 214 also receives image data from a user and utilizes the image data to identify an item depicted or described by the image data.

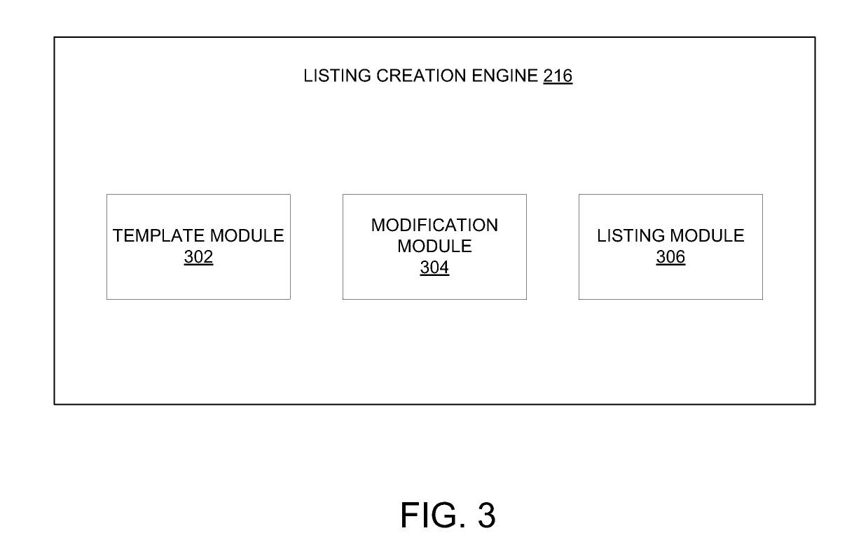

A listing creation engine 216 allows sellers to conveniently author listings of items. In one embodiment, the listings pertain to goods or services that a user (e.g., a seller) wishes to transact via the publication system 120. In other embodiments, a user may create a listing that is an advertisement or other form of publication. The listing creation engine 216 will be discussed in more detail in connection with FIG. 3.

A listing management engine 218 allows sellers to manage such listings. Specifically, where a particular seller has authored or published a large number of listings, the management of such listings may present a challenge. The listing management engine 218 provides a number of features (e.g., auto-relisting, inventory level monitors, etc.) to assist the seller in managing such listings.

A post-listing management engine 220 also assists sellers with a number of activities that typically occur post-listing. For example, upon completion of an auction facilitated by the one or more auction engines 204, a seller may wish to leave feedback regarding a particular buyer. To this end, the post-listing management engine 220 provides an interface to the reputation engine 210 allowing the seller to conveniently provide feedback regarding multiple buyers to the reputation engine 210.

A messaging engine 222 is responsible for the generation and delivery of messages to users of the networked system 102. Such messages include, for example, advising users regarding the status of listings and best offers (e.g., providing an acceptance notice to a buyer who made a best offer to a seller). The messaging engine 222 may utilize any one of a number of message delivery networks and platforms to deliver messages to users. For example, the messaging engine 222 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, WiMAX).

Although the various components of the publication system 120 have been defined in terms of a variety of individual modules and engines, a skilled artisan will recognize that many of the items can be combined or organized in other ways. Furthermore, not all components of the publication system 120 have been included in FIG. 2. In general, components, protocols, structures, and techniques not directly related to functions of example embodiments (e.g., dispute resolution engine, loyalty promotion engine, personalization engines, etc.) have not been shown or discussed in detail. The description given herein simply provides a variety of example embodiments to aid the reader in an understanding of the systems and methods used herein.

### Application of Embodiments of the Slider Histogram for Listing Creation in the Example Network Architecture

Referring now to FIG. 3, an example diagram of the listing creation engine 216 is shown. The listing creation engine 216, in conjunction with the navigation engine 212, provides mechanisms to create listings by using information from other listings for a same or similar item. The listing creation engine 216 comprises a template module 302, a modification module 304, and a listing module 306. Alternative embodiments may comprise further components or modules not directly related to example embodiments of listing creation using a slider histogram, and thus are not shown or discussed. Furthermore, some of the components of the listing creation engine 216 may be located elsewhere (e.g., in the navigation engine 212) or be located at the client device 110.

In example embodiments, a user (e.g., seller) may search or browse previously sold or currently available item listings in a publication system. When the user finds a listing for an item that the user would like to sell themselves, the user may select a “sell one like this” (or similar) button on a user interface on which the listings are provided. With the selection of the button, the listing creation engine 216 initiates a listing creation process.

The template module 302 extracts common attribute data associated with the listing on which the user has selected the button and uses the attribute data to pre-populate a template. The template may be a template used to generate an item listing to sell the item. In example embodiments, the template module 302 accesses the information from the selected listing and strips out any previous user-generated content which may not apply to the user's item. The remaining information (e.g., information in common for both items) is then used to pre-populate the template. The pre-populated information may include category, title, description, shipping method, images, and price (or price range). The pre-populated information on the template is a recommendation for the user. The user may modify the pre-populated information accordingly.

The modification module 304 manages these modifications to the pre-populated template. In some embodiments, the modifications may be text input received from the client device 110. The text input is then used to update or change information in fields of the template.

In other embodiments, the modifications may be received from the client device 110 of the user as voice data. In these embodiments, a voice recognition module (not shown) of the listing creation engine 216 converts the voice data to text data. The modification module 304 then takes the text data and modifies the pre-populated template. Alternatively, the client device 110 may convert the voice data (e.g., using a device voice recognition module) and the modification module 304 receives the modified data as text input. Modification of the pre-populated template results in a final template that may be used to generate the listing.

The listing module 306 generates the listing using the attribute information and any modified data from the final template. The listing may include an image of the item as well as any other information obtained from the selected listing and provided by the user as modified data. In various embodiments, the listing may be a listing for publication to the network-based publication system, advertisements, or other publications. For example, the listing may be an item listing published to an online auction site.

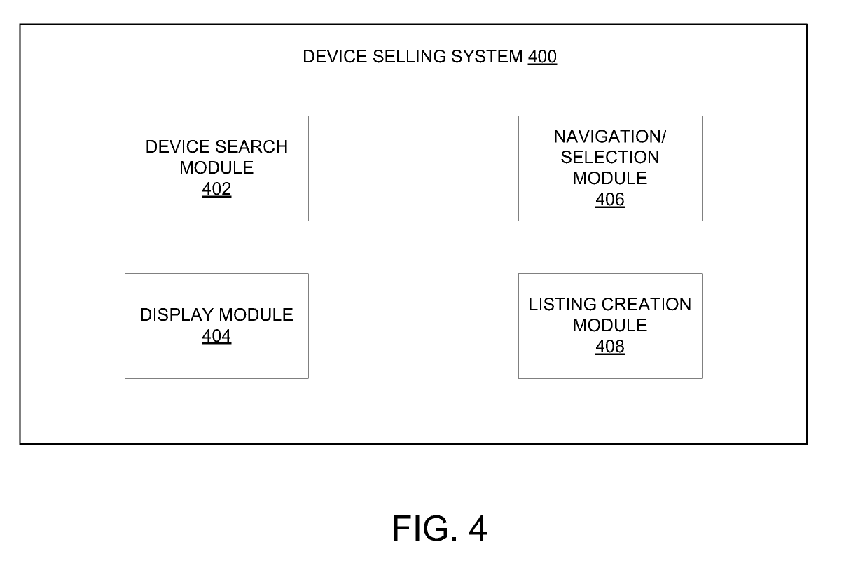

FIG. 4 is a block diagram illustrating an example embodiment of a device selling system 400 located at the client device 110. The device selling system 400 may be embodied on a machine-readable storage medium on the client device 110. When activated, the device selling system 400 allows the client device 110 to perform functions related to listing and selling items on the publication system 120. In example embodiments, the device selling system 400 comprises a device search module 402, a display module 404, a navigation/selection module 406, and a listing creation module 408.

The device search module 402 provides a mechanism to perform a search on the client device 110. For example, the device search module 402 may provide a field in which terms for a keyword or free-text search may be entered. In other embodiments, searches may be performed based on an imported image. Additionally, the device search module 402 may allow the user to browse for information.

During the searching process, the display module 404 displays a user interface. The user interface may include listings of items previously sold, currently available, or a combination of both. Additionally, the slider histogram is displayed along a portion of the user interface by the display module 404.

Using the navigation/selection module 406, the user may move a slider of the slider histogram to refine the listings displayed by the display module 404. When a particular listing is of interest to the user, the user may select the listing for a more detailed view of the listing. Within the detailed view of the listing, a “sell one like this” button is provided. When the user selects the button, the navigation/selection module 406 triggers the listing creation process.

The listing creation module 408 handles the listing creation functions at the client device 110. Initially, the listing creation module 408 receives the pre-populated template that is generated by the template module 302 of the listing creation engine 216. The user may then provide modifications to the pre-populated template via the listing creation module 408. The modifications are then returned to the listing creation engine 216 of the publication system 120.

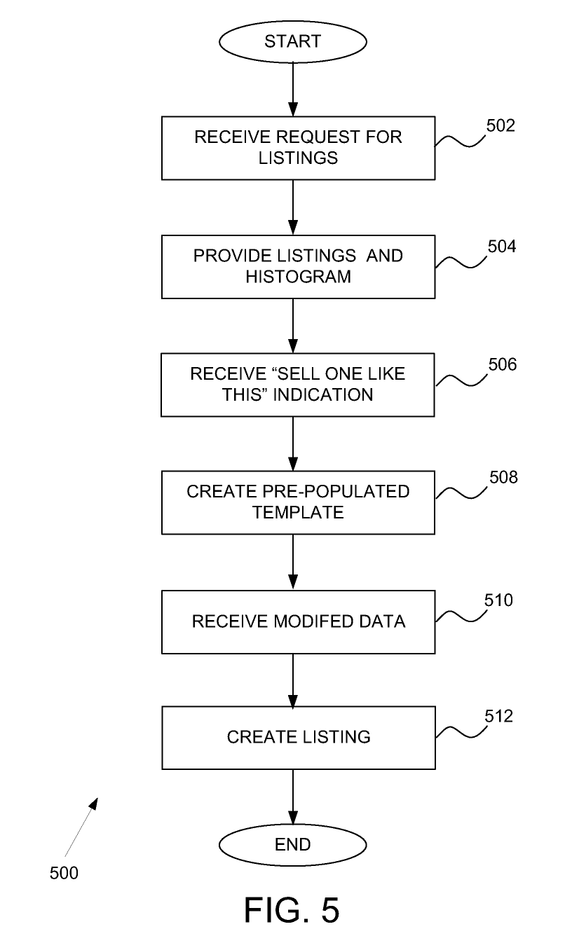

FIG. 5 is a flow diagram of an example method 500 for creating a listing based on an existing listing (e.g., previously sold or currently available listing) for a same or similar item at the publication system 120. At operation 502, a request for listing is received from the client device 110. The request may include terms for a search, one or more browsing or navigation instructions, or any other information which provides the navigation engine 212 with an indication of listings or content that the user desires to view. In one embodiment, the request is for listings for items that have been sold within a particular time period (e.g., within the last 30 days).

At operation 504, results based on the request are determined and provided to the client device 110. The results include a histogram generated based on the results. The histogram may be used by the user at the client device 110 to navigate the results. In an example embodiment, the histogram may depict a distribution of search or browsed results on the basis of a value of an attribute common to the results. For example, the histogram may depict a distribution of the results by price values. In one example embodiment, the results may be depicted in the histogram as a distribution or series of vertical lines, with the relative thickness of each line indicating the number or concentration of results having the same or similar attribute value. In some embodiments, the movement of the slider on the histogram provides an input to the histogram module 224 at the publication system 120 to refine the priority of the listings being displayed (e.g., higher prioritized listings being shown first). In other embodiments, the refinement may occur at the client device 110 (e.g., where the client device receives all the listings and can determine how best to display the listings itself) and is handled by the navigation/selection module 406.

Based on the user identifying a listing from the results for an item that the user desires to sell themselves, the user may select a “sell one like this” button at the user device 110. As a result, the publication system 120 receives a “sell one like this” indication at operation 506. The indication may include an identification of the selected listing. Using the identification, the template module 302 at the listing creation engine 216 retrieves the listing information, strips out any user-generated information specific to the selected listing, and pre-populates a template at operation 508. The template comprises a basic collection of information regarding the user's item that may be subsequently used to generate a listing or perform other actions (e.g., perform a web-based search). The information may pre-populate any number of fields in the template. The pre-populated template is then transmitted back to the user of the client device 110. It should be noted that the template may be in any form. For example, the template may simply be a listing of attribute information without any formatting, which may be subsequently formatted by the client device 110 for display.

At operation 510, modified data is received, which results in a final template that is used to generate the listing. The modified data may comprise the final template itself, in accordance with one embodiment. In another embodiment, the modified data may comprise text data (e.g., received from a voice recognition module of the client device 110 or from a keyboard device of the client device 110) that is used to update the pre-populated template to generate the final template. In yet another embodiment, the modified data may comprise voice data. The voice data is converted to text data and the text data is used to modify the pre-populated template into the final template.

In example embodiments, the final template comprises a collection of attribute information that may be used to generate the listing for the item. In operation 512, the listing is generated based on the final template, and the listing may be posted to the publication system 120.

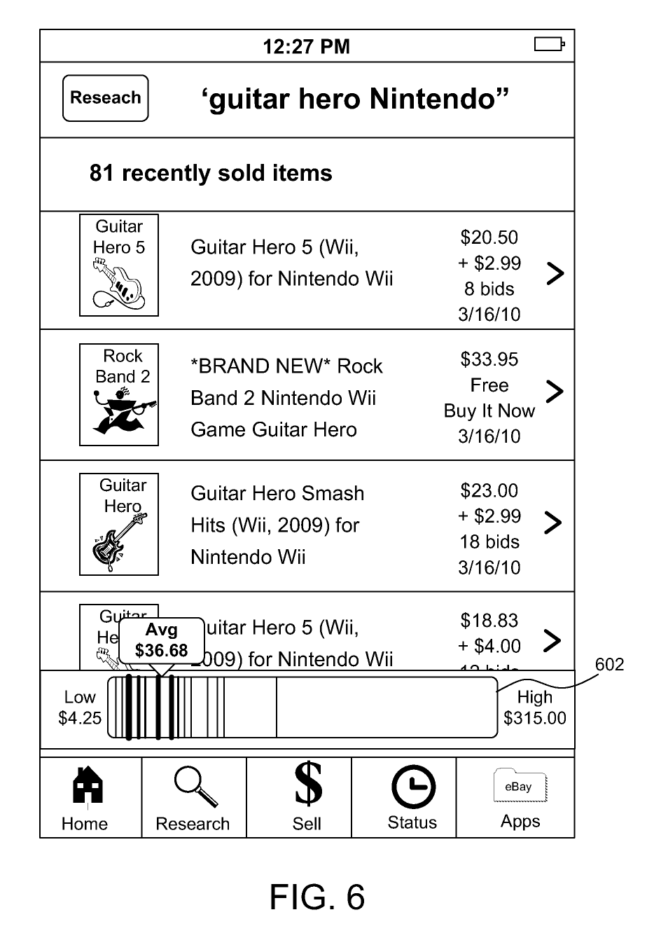

FIG. 6 is an example user interface illustrating a pricing histogram 602 on a price history display shown on the client device 110. The example is provided based on a search performed for “guitar hero Nintendo.” In the present example, the user is searching previously sold items. The user may desire to perform this search in order to determine a price range of previously sold items for which the user may want to offer a same item for sale.

The histogram 602 is provided at a bottom portion of the display. The histogram 602 may be based on the sold items within a particular time period. In this example, 81 items related to “guitar here Nintendo” have recently sold. The histogram 602 indicates a range between a lowest price and a highest price these items have sold for. The lowest price and the highest price may also be provided adjacent to the histogram 602, as shown. A thicker line or more lines on the histogram 602 indicates a price range where more items were sold. Additionally, an average price may be indicated on the display. In example embodiments, the user may refine the listings currently displayed on the display by sliding a slider on the histogram 602 to a particular price or price range.

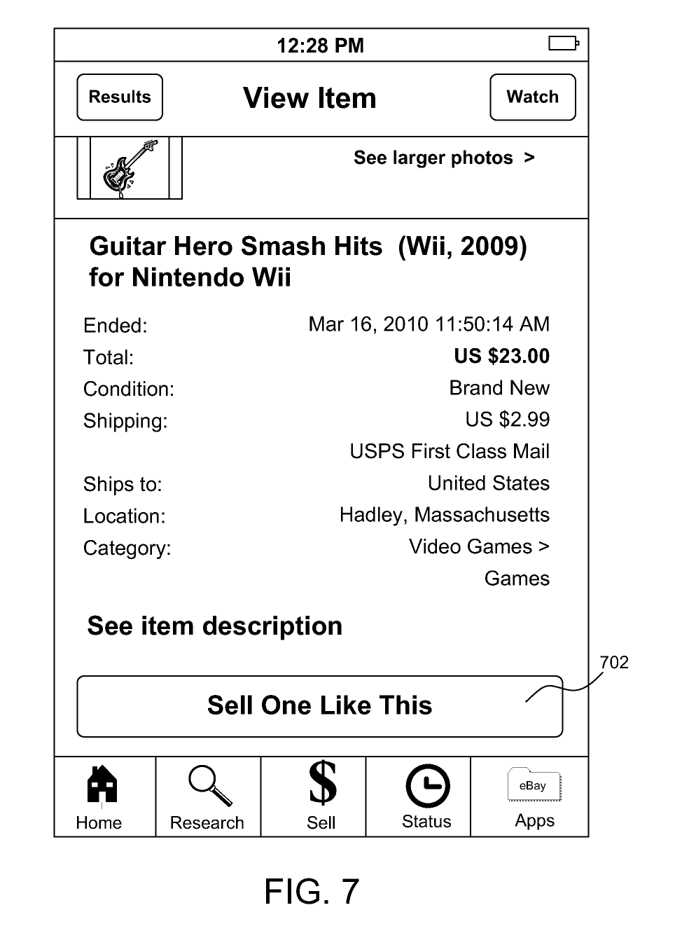

Once the user finds a listing the user is interested in, the user may select the listing in order to view the listing in more detail. FIG. 7 is an example user interface illustrating a listing in more detail. Included on the selected listing is a “sell one like this” button 702. Should the user have a same item that the user wants to sell, the user may select the “sell one like this” button 702. The selection of the button triggers the listing creation process as discussed in FIG. 5.

While the listing depicted in FIG. 7 is reached using the slider histogram in the present embodiment, alternative embodiments may not utilize a slider histogram in order to reach the selected listing. For example, the user may perform keyword searches and browse through listing to reach a selected listing. Once on the selected listing, the user may then activate the “sell one like this” button 702.

Embodiments of the present application allow a user to quickly and easily generate an item listing based on an existing listing (e.g., previously sold listing or currently available listing). By finding an existing listing that is directed to the same item, information from the existing listing may be extracted and used to pre-populate a template. The extracted information may include, for example, category, title, description, shipping method, shipping cost, images, and price. The user may merely approve the pre-populated template to list the user's item for sale. Alternatively, the user may modify or add more information to the template. A listing is then generated based on a final template (e.g., template approved by the user).

In some embodiments, information specific to the user may be obtained from a user profile associated with the user and used to pre-populate the template. For example, the user's location may be determined from the user's profile.

Example embodiments further allow uniqueness or oddities associated with the item to be easily acknowledged. A standard catalog of items may not account for these uniqueness or oddities. However, a listing of a same item which may include unique attributes (e.g., color, size, autographed, artist proof) is identified, and the information from the selected listing may be used as a basis to generate a new item listing.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Storage Medium

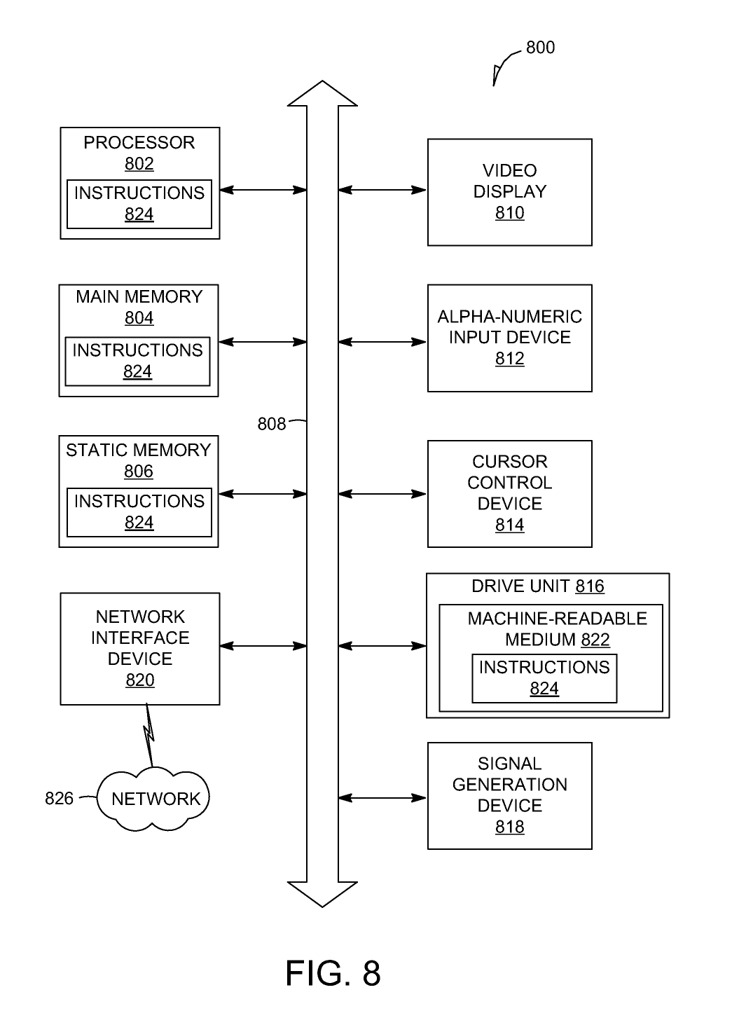

With reference to FIG. 8, an example embodiment extends to a machine in the example form of a computer system 800 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 may include a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). In example embodiments, the computer system 800 also includes one or more of an alpha-numeric input device 812 (e.g., a keyboard), a user interface (UI) navigation device or cursor control device 814 (e.g., a mouse), a disk drive unit 816, a signal generation device 818 (e.g., a speaker), and a network interface device 820.

### Machine-Readable Medium

The disk drive unit 816 includes a machine-readable storage medium 822 on which is stored one or more sets of instructions 824 and data structures (e.g., software instructions) embodying or used by any one or more of the methodologies or functions described herein. The instructions 824 may also reside, completely or at least partially, within the main memory 804 or within the processor 802 during execution thereof by the computer system 800, with the main memory 804 and the processor 802 also constituting machine-readable media.

While the machine-readable storage medium 822 is shown in an example embodiment to be a single medium, the term “machine-readable storage medium” may include a single storage medium or multiple storage media (e.g., a centralized or distributed database, or associated caches and servers) that store the one or more instructions. The term “machine-readable storage medium” shall also be taken to include any tangible medium that is capable of storing, encoding, or carrying instructions for execution by the machine and that cause the machine to perform any one or more of the methodologies of embodiments of the present application, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 824 may further be transmitted or received over a communications network 826 using a transmission medium via the network interface device 820 and utilizing any one of a number of well-known transfer protocols (e.g., Hypertext Transfer Protocol (HTTP)). Examples of communication networks include a local area network (LAN), a wide area network (WAN), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present application. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived there from, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present application. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present application as represented by the appended claims. The specification and drawings are, accordingly, to be regarded in an illustrative rather than a restrictive sense.

What is claimed is:

1. A method comprising:
receiving a request from a client device;
determining, using one or more processors, a list of item listings satisfying the request;
generating a histogram based on an attribute found in the item listings of the list; and
providing the list and the histogram to the client device, the histogram including a slider that allows refinement of the item listings being displayed based on a position of the slider on the histogram.

2. The method of claim 1, further comprising receiving a slider input and refining the item listings based on the slider input.

3. The method of claim 1, further comprising receiving an indication to sell a first item similar to a second item included in a selected item listing from the list.

4. The method of claim 3, further comprising extracting information associated with the selected item listing and using the extracted information to pre-populate a template.

5. The method of claim 4, further comprising receiving modified data used to modify the pre-populated template.

6. The method of claim 4, further comprising generating a new item listing for the first item using the pre-populated template.

7. The method of claim 4, wherein the extracted information comprises at least one of a category, a title, a description, a shipping method, a shipping cost, an image, or a price.

8. The method of claim 1, wherein the item listings are product listings for a network-based marketplace.

9. The method of claim 1, wherein the attribute is at least one of price, item size, item color, item condition, reputation of sellers of the item listings, or item location.

10. The method of claim 1, wherein the histogram displays a distribution of the item listings according to the attribute.

11. A machine-readable storage medium storing instructions which, when executed by at least one processor, causes the at least one processor to perform operations comprising:
receiving a request from a client device;
determining a list of item listings satisfying the request;
generating a histogram based on an attribute found in the item listings of the list; and
providing the list and the histogram to the client device, the histogram including a slider that allows refinement of the item listings being displayed based on a position of the slider on the histogram.

12. The machine-readable storage medium of claim 11, wherein the operations further comprise receiving a slider input and refining the item listings based on the slider input.

13. The machine-readable storage medium of claim 11, wherein the operations further comprise receiving an indication to sell a first item similar to a second item included in a selected item listing from the list.

14. The machine-readable storage medium of claim 13, wherein the operations further comprise extracting information associated with the selected item listing and using the extracted information to pre-populate a template.

15. The machine-readable storage medium of claim 14, wherein the operations further comprise receiving modified data used to modify the pre-populated template.

16. The machine-readable storage medium of claim 11, wherein the attribute is at least one of price, item size, item color, item condition, reputation of sellers of the item listings, and item location.

17. The machine-readable storage medium of claim 14, wherein the operations further comprise generating a new item listing for the first item using the pre-populated template.

18. The machine-readable storage medium of claim 14, wherein the extracted information comprises at least one of a category, a title, a description, a shipping method, a shipping cost, an image, and a price.

19. The machine-readable storage medium of claim 11, wherein the histogram displays a distribution of the item listings according to the attribute.

20. A system, comprising:
a navigation engine configured to:
receive a request from a client device; and
provide a list of item listings satisfying the request to the client device; and
a histogram module configured to generate and provide a histogram to the client device, the histogram based on an attribute found in the item listings of the list, the histogram including a slider that allows refinement of the item listings being displayed based on a position of the slider on the histogram.
